(19) United States
(12) Patent Application Publication
(10) Pub. No.: US 2025/0308393 A1
(43) Pub. Date: Oct. 2, 2025

(54) SYSTEM AND A METHOD FOR FLIGHT MANAGEMENT AND OPERATION

(71) Applicant: Airable Aviation Inc., Richmond (CA)

(72) Inventor: Saeed Golzar, North Vancouver (CA)

(21) Appl. No.: 19/081,086

(22) Filed: Mar. 17, 2025

Related U.S. Application Data
(60) Provisional application No. 63/572,096, filed on Mar. 29, 2024.

(51) Int. Cl. G08G 5/34; G08G 5/21

(52) U.S. Cl. CPC G08G 5/34; G08G 5/21

(57) ABSTRACT

Embodiments of the present disclosure relate to a system and device for generating and providing a list of possible options for re-routing or changing the flights based on user-specific query. The system identifies if there are one or more empty legs in one more flight between a departure location and an arrival location provided by a user at the user device. The system also identifies if there are one or more alternative flights available to re-route to reach the departure location and pick passengers. Based on identification, the system accepts or rejects the user query and accordingly generates a list of possible options to which said user may with a selection of a best-suited flight.

### TECHNICAL FIELD

The disclosure generally relates to commercial airlines managing, scheduling and booking. More particularly, the disclosure relates to systems, devices, articles and methods for providing possible options to change flight routes and/or time based on user queries and input from aircraft operators.

### BACKGROUND

The purpose of the following description of related art is solely to provide background information pertaining to the relevant field of the disclosure. It should be noted that this section is only to enhance the understanding of the reader with respect to the present disclosure. Therefore, unless otherwise indicated, it should not be assumed that any of the information described in this section qualifies as prior art merely by virtue of their inclusion in this section.

Private jets and charter flights have gained immense popularity and convenience due to their inherent benefits. Typically, these flights are scheduled according to the customer's needs and preferences rather than predetermined timings. As a result, the aircraft are organized as needed, often shortly before the departure time. This flexibility allows customers who are behind or ahead of schedule to adjust their flight times, with the charter service provider accommodating such changes.

While charter flights offer benefits, they also face challenges in achieving full seat occupancy. Often, an aircraft will carry passengers to a destination and return to its point of origin without any passengers, a situation known as “empty legs” or “unoccupied seats” which leads to losses. Moreover, these empty flights contribute to environmental concerns due to the substantial carbon emissions they generate. Consequently, there is a lack of market interest in such unoccupied flights.

### SUMMARY

This section is intended to introduce certain objectives and aspects of the present disclosure in a simplified manner. The disclosure relates to a method of flight management and operation in a system including at least one processor, and a user device in communication with the at least one processor. The method includes receiving, at the at least one processor from the user device, a user query comprising a departure location, an arrival location, a departure time and a number of passengers; analysing, by the at least one processor, a flight database, to: identify if there is one or more empty leg in one or more flights between the departure location and the arrival location, and identify if there is one or more alternative flights available to re-route to reach the departure location to pick the number of passengers, wherein the flight database includes information characterizing one or more aircraft operators, a plurality of routes, alternative routes for the plurality of routes, a plurality of departure locations, a plurality of arrival locations, number of occupied seats, number of total seats; accepting or rejecting, by the at least one processor, the user query based on the analysis of the flight database, wherein the user query is accepted by the at least one processor if the one or more empty leg is identified, and the user query is rejected by the at least one processor if the one or more empty leg is not identified; generating, by the at least one processor, a list of possible options for flights for a user if the user query is accepted, wherein said possible options refers to change in at least one of the departure time, the arrival location, the plurality of routes and the alternative routes to accommodate the number of passengers; and providing, by the at least one processor to the user device, the list of possible options, wherein the user device may respond with a selection of a best-suited flight the list.

In one embodiment, the method includes providing, by the at least one processor to an aircraft operator of the best-suited flight, the list of the possible options and the best-suited flight. In another embodiment, the method includes notifying the user device in an event the aircraft operator of best-suited flight rejects the change in the flight. In yet another embodiment, the method includes determining if there is any affect on existing passengers of the best-suited flight in an event the flight is changed. Further, in an embodiment, the list of possible options is provided to the user at the user device in a ranking order based on cost, the departure time or the arrival time. Furthermore, in an embodiment, the method includes providing processor-executable instructions, which when executed, provides an option to the user at the user device to update the user query, and receive an updated user query from the user at the user device. Additionally, the flight database is also updated if the information received by the one or more aircraft operator includes an update.

Further, the embodiments of the present disclosure encompass a system a user device, wherein the user device is processor-based; at least one processor communicatively coupled to the user device; and at least one non-transitory processor-readable storage device communicatively coupled to the at least one processor and which stores processor-executable instructions which, when executed by the at least one processor, cause the at least one processor to: receive a user query comprising a departure location, an arrival location, a departure time, and a number of passengers; analyse a flight database, to identify if there is one or more empty leg in one or more flights between the departure location and the arrival location; identify if there is one or more alternative flights available to re-route to reach the departure location to pick the number of passengers; accept or reject the user query based on the analysis of the flight database, wherein the user query is accepted if the one or more empty leg is identified, and the user query is rejected if the one or more empty leg is not identified; generate a list of possible options for flights for a user at the user device if the user query is accepted, wherein said possible options refers to change in at least one of the departure time, the arrival location, the plurality of routes and the alternative routes to accommodate the number of passengers; and provide the list of possible options to the user device, wherein the user device may respond with a selection of best-suited flight the list.

In one embodiment, the at least one processor provides the list of the possible options and the best-suited flight to aircraft operator of the best-suited flight. In another embodiment, the at least one processor notifies the user device if the aircraft operator of the best-suited flight rejects the change in the best-suited flight. In another embodiment, the list of possible options is presented to the user device in a ranking order based on cost, the departure time or the arrival time. In one embodiment, the at least one processor cause the at least one processor to provide an option to the user at the user device to update the user query and receive an updated user query from the user at the user device. In another embodiment, the at least one processor updates the flight database if the information received by one or more aircraft operator includes an update.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Systems, devices, and methods are described in greater detail herein with reference to the following figures in which:

FIG. 1 illustrates a general overview of the system architecture, wherein the system includes a plurality of circuits.

FIG. 2 illustrates an overview of user device architecture connected to various components working together.

FIG. 3 illustrates in schematic view a network including a plurality of aerodromes and a plurality of routes amongst the plurality of aerodromes.

FIG. 4 illustrates an implementation of a method of flight management and operation of the plurality of circuits or user device.

FIG. 5 illustrates an implementation of a method of flight management and operation of the plurality of circuits or user device.

The above-mentioned drawings illustrate exemplary embodiments of the disclosed methods and systems in which like reference numerals refer to the same parts throughout the different drawings. Components in the drawings are not necessarily to scale, emphasis instead being placed upon clearly illustrating the principles of the invention. Some drawings may indicate the components using block diagrams and may not represent the internal circuitry of each component. Also, the embodiments shown in the figures are not to be construed as limiting the invention but only as illustrative examples of an automated method and system according to the invention that are illustrated herein to highlight the advantages of the invention.

### DETAILED DESCRIPTION

In the following description, associated drawings, included claims, and other parts of the document, various details are set forth to provide a detailed understanding of the disclosure and embodiments thereof. It will be apparent, however, that the disclosed embodiments may be practiced without these details. Several features described hereafter can each be used independently of one another or with any combination of other features.

Hence, in view of the above-mentioned problems and challenges, the Applicant appreciates there is a need for an efficient system and method for managing empty leg and flight routes and accordingly recommending possible options based on user queries.

Embodiments of the present disclosure relate to a system and a method for managing and operating flight routes by recommending/providing possible changes required top accommodate new passengers to overcome empty leg. A user query is received from a user device comprising a departure location, an arrival location, departure time and a number of passengers. Further, a flight database comprising information (characterizing one or more aircraft operators and other details mentioned later in the disclosure) is analysed to identify if there is one or more empty leg in one or more flights between the departure location and the arrival location, and to identify if there is one or more alternative flights available to re-route to reach the departure location to pick the number of passengers. Based on said analysis, the user query is accepted or rejected, wherein the user query is accepted if the empty leg(s) are identified, and the user query is rejected if the empty leg(s) are not identified. If the user query is accepted, a list of possible options is generated for flights for the user at the user device and provided to the user device where the user device selects a best-suited flight amongst the options. Said options can be change in at least one of the departure time, the arrival location, the plurality of routes and the alternative routes to accommodate the number of passengers.

The system and method also provide option to update the user query. Moreover, the system may be adapted to operate completely or in parts at a user device level, a server level, or a combination thereof.

As used herein, the term “empty leg” refers to vacant seats or unoccupied seats or available seats for booking in a flight.

The term “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two units or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, “input”, “send”, “transfer”, “transmit”, “receive”, “output” and their cognate terms refer to sending and/or receiving information from one unit to another unit of the system, wherein said information refer to all the data mentioned in the disclosure and may or may not be modified before or after sending and receiving the information according to the desired requirements.

As used herein, the term “alternative” refers to other possibilities available in accordance with the invention. The terms ‘alternative’ and ‘alternate’ may be interchangeably used throughout the specification.

The I/O device(s) as used herein includes one or more user interface input devices, such as a display, a keyboard, a mouse, a microphone, and a camera. The one or more user interface input devices may be detachable. In some embodiments, the I/O device(s) includes one or more output devices, such as displays, speakers, and lights. In some embodiments, the I/O device(s) is a single light. The one or more I/O devices may be detachable. The I/O device(s) may include one or more sensors (such as altimeters, transducers, thermometers, force sensors, strain gauge, clock) and output devices (such as actuators, displays, lights).

The terms “passenger”, “user” and “traveller” may refer to same person and the terms may be interchangeably used throughout the specification.

The processor may be any logic processing unit such as one or more microprocessors, central processing units (CPUs), digital signal processors (DSPs), graphics processing units (GPUs), application-specific integrated circuits (ASICs), programmable gate arrays (PGAs), programmed logic units (PLUs) or any such device as may be obvious to a person skilled in the art. The processor may include, but is not limited to, a processor or set of processors or any such processing unit as may be obvious to a person skilled in the art, that are configured to function in accordance with the invention. The terms ‘processor’ and ‘processing unit’ may be interchangeably used throughout the specification.

The circuits as used herein refers to any components, units, hardware element or any such unit as may be obvious to a person skilled in the art.

A variety of approaches have been developed to overcome the issue of the utilization of charter aircraft, including offering one-way pricing. Ride-sharing is also promoted, allowing different passengers to share a flight from a common origin to a common destination, or for part of the journey. Additionally, selling seats on empty return flights at discounted rates is another economical approach. Despite these efforts, there remains a lack of dependable resources for locating and reserving seats on these “empty-leg” flights. Current systems also do not adequately consider the dynamic market value when presenting routes to passengers or adjusting flight routes and schedules to include additional travelers.

The Applicant appreciates to overcome the problems inherent in the existing solutions, there exists a need for an efficient system and method for managing and scheduling private commercial aviation. In particular, there is a need for efficiently find options to accommodate empty leg and/or accommodate new passengers for empty seats in a scheduled flight based on user-specific query.

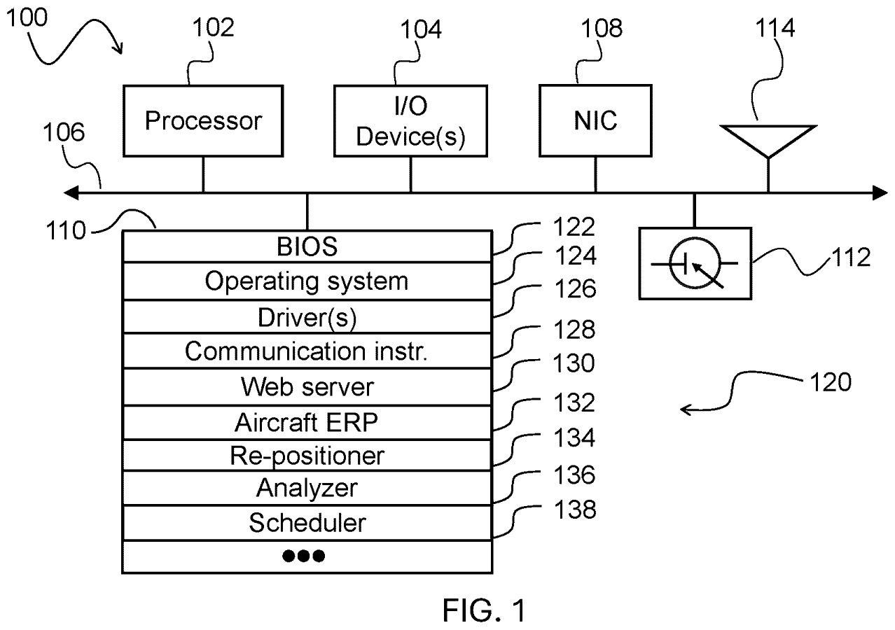

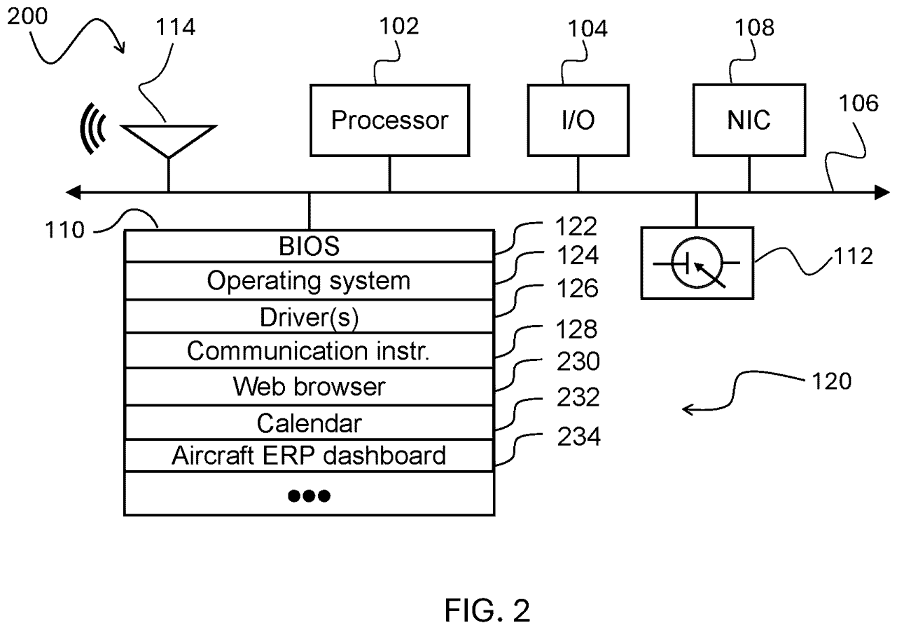

FIG. 1 illustrates a schematic view of aspects of a plurality of circuits 100 in accordance with some embodiments of the invention. The plurality of circuits 100 includes a control subsystem comprising at least one processor 102, at least one input/output (I/O) subsystem 104, and at least one bus 106 to which, or by which, the at least one processor 102 and the I/O device(s) 104 are communicatively coupled. A user device 200 is communicatively coupled to the plurality of circuits 100 and is further described in relation to, at least, FIG. 2.

Further, the plurality of circuits 100 includes a Network Interface Card (NIC) or network interface subsystem 108 communicatively coupled to bus(es) 106, wherein the network interface subsystem 108 provides bi-directional communication to other components (e.g. a system external to plurality of circuits 100) through one or more network or non-network communication channel(s) such as internet. In some embodiments, the network interface subsystem 108 includes a circuitry. In another embodiment, the network interface subsystem 108 uses communication protocols (e.g. FTP, HTTP, Web Services, and SOAP with XML) for bidirectional communication of information including processor-readable data, and processor-executable instructions.

Furthermore, the plurality of circuits 100 includes at least one non-transitory computer or processor-readable storage device(s) 110 coupled to the bus(es) 106. The terms ‘non-transitory computer’ and ‘processor-readable’ may be interchangeably used throughout the specification. Further, said storage device(s) 110 includes at least one non-transitory storage medium. In one embodiment, the storage device(s) 110 includes two or more distinct devices, while in another embodiment, the storage device(s) 110 includes one or more volatile storage devices (e.g. Random Access Memory (RAM)), and one or more non-volatile storage devices (e.g. Read Only Memory (ROM), flash memory, magnetic hard disk (HDD), optical disk, solid state disk (SSD), and the like). In an embodiment, the storage device(s) 110 may be implemented in a variety of ways such as a read-only memory (ROM), random access memory (RAM), a hard disk drive (HDD), a network drive, flash memory, digital versatile disk (DVD) or any such forms as may be obvious to a person skilled in the art. Further, modern computer systems and techniques conflate volatile storage and non-volatile storage, for example, caching, using solid-state devices as hard drives, in-memory data processing, and the like.

The storage device(s) 110 may store on or within the included storage media processor-readable data and/or processor-executable instructions. Storage device(s) 110 include or store processor-executable instructions and/or processor-readable data 120 associated with the operation of plurality of circuits 100, a plurality of aircraft, and the like. The terms ‘processor-executable instructions’ and ‘processor-readable data’ may be interchangeably used throughout the specification.

In some embodiments, the processor-executable instructions/data 120 include a Basic Input/Output System (BIOS) 122, an operating system 124, driver(s) 126, communication instructions/data 128, a web server 130, an aircraft ERP 132, a re-positioner 134, an analyzer 136, a scheduler 138, a flight database 140 and the like.

In an exemplary scenario, the operating system 124 is ANDROID®, LINUX®, WINDOWS® and the like. The driver(s) 126 include processor-executable instructions/data that allows the at least one processor 102 to control one or more components in the plurality of circuits 100. The processor-executable communication instructions/data 128 implements communications between the plurality of circuits 100 and another processor-based device through network interface subsystem 108 in accordance with the invention.

The plurality of circuits 100 further includes one or more power supplies 112. In one embodiment, the power supply(ies) 112 are external power supply(ies), while in another embodiment, the power supply(ies) 112 are on-board power source(s) such as batteries, ultra-capacitors, or fuel cells, to independently power different components in accordance with the invention.

Also, the plurality of circuits 100 includes at least one antenna 114. In response to processor-executable instructions, the antenna 114 emits electronic signals and receive electronic signals in accordance with the invention.

The processor-executable communication instructions/data 120, when executed, directs the plurality of circuits 100 to process input from I/O device(s) 104, antenna 114, or sensors included in a wider system, information that represents input stored on or in a storage device, e.g., storage device(s) 110. In some embodiments, the processor-executable input instructions 120, when executed, direct the plurality of circuits 100 to communicate with each other in accordance with the invention.

In some embodiments, the aircraft Enterprise Resource Planning (ERP) 132, includes processor-executable input instructions or data which, when executed, directs the plurality of circuits 100 to write, update, or provide information about operational details of one or more aircraft. The aircraft ERP 132 integrates and automates various systems of record. In one embodiment, the aircraft ERP 132 includes processor-executable instructions or data, which when executed, updates and/or provides information characterizing aircraft Maintenance, Repairs, and Operations (MRO) information. In another embodiment, the aircraft ERP 132 includes instructions to provide real-time or near real-time data on one or more aircraft. For example, location information, instrument data, and other data to monitor aircraft health, usage, and compliance.

In some embodiments, the flight database 140 includes information characterizing one or more aircraft operators, a plurality of routes, alternative routes for the plurality of routes, a plurality of departure locations, a plurality of arrival locations, number of occupied seats, number of total seats and the like. Aircraft ERP 132 may store and retrieve records from the flight database 140.

The user device 200 transmits the user query to the at least one processor 102, wherein the user query comprises the departure location, the arrival location, the departure time and the number of passengers. In an embodiment, the number of passengers refer to as count of passengers travelling. The term ‘time’ used throughout the disclosure refers to time and date. In some embodiments, the processor-executable input instructions 120, when executed, directs the plurality of circuits 100 to provide an option to the user device 200 to update the user query. In an embodiment, the user device 200 can be of a traveller or passenger. In another embodiment, the user device 200 can be of a non-traveller (for example-operator, aircraft crew or any such person excluding traveller as may be obvious to a person skilled in the art. Thus, the option to change the user query is provided to a traveller or a non-traveller as mentioned above.

In some embodiments, the web server 130, includes processor-executable instructions or data, which when executed, direct the plurality of circuits 100 to deliver content to devices (e.g., user devices) across a network (e.g., Internet). In some embodiments, the web server 130 includes a plurality of hosted files and instructions, which when executed, provides access to the hosted files. In some embodiments, the web server 130 includes an HTTP server that processes URLs (addresses) and HTTP (the protocol your browser uses to view webpages).

The analyzer 136 includes processor-executable instructions which, when executed, directs the plurality of circuits 100 to process input from the web server 130 that represents a travel request (i.e. the user query). Further, said analyser 136, when executed, directs the plurality of circuits 100 to analyse the flight database 140 to identify if there identify if there is one or more empty leg in one or more flights between the departure location and the arrival location. Said analyser 136 identifies if there is one or more alternative flights available to re-route to reach the departure location to pick the number of passengers.

Further, the processor-executable re-positioner 134, when executed, directs the plurality of circuits 100 to accept or reject the user query based on the analysis of the flight database. In one embodiment, the user query is accepted if the one or more empty leg is identified whereas in another embodiment, the user query is rejected (i.e. not accepted) if the one or more empty leg is not identified.

On accepting the user query, the processor-executable re-positioner 134 generates a list of possible options for the flights for the user at the user device 200, wherein said possible options refers to change in at least one of the departure time, the arrival location, the plurality of routes and the alternative routes to accommodate the number of passengers. For example, if the user query has asked for flights from location C to B and the original flight is currently scheduled from location A to B via route A-B, then said re-positioner 134 will re-route the original flight to reach location C to pick new passengers, thereby changing original route from A-B to A-C-B. In another example, if the user query has asked for flights from location C to B at a new time, and the original flight is currently scheduled to take off at old time, then said re-positioner 134 will change the flight timing from the old time to the new time to accommodate new passengers, wherein the new time can be earlier or later than the old time i.e. changing either the arrival time or the departure time.

Further, the list of possible options is presented to the user device 200 from which the user at the user device 200 may select the best-suited flight. Therefore, user at the user device 200 may respond back with the selection of the best-suited flight. Further, details of the list of possible options and the best-suited flight are provided to an aircraft operator of said best-suited flight. In an embodiment, if the aircraft operator of the best-suited flight rejects the change in said best-suited flight, the user device 200 is notified.

In an embodiment, the list of possible options is provided to the user device 200 to the user device 200 in a ranked order based on based on cost, the departure time, the arrival time and like.

In some embodiments, the processor-executable analyser 136 determines if there is any affect on existing passengers of the best-suited flight in an event said best-suited flight is changed.

Further, the processor-executable analyser 136, when executed, directs the plurality of circuits 100 to update the flight database 140 in an event the information received by the one or more aircraft operator is updated

In some embodiments, the re-positioner 134 and the analyzer 136 are combined in to one set of processor-executable instructions and processor-readable data.

The processor-executable instructions 120 includes the scheduler 138, which when executed, directs the plurality of circuits 100 to allow the user at the user device 200 to book or schedule the best-suited flight. In some embodiments, the scheduler 138 queries the flight database 140.

Turning to FIG. 2 which illustrates a schematic view of aspects of user device 200 in accordance with some embodiments of the invention. The user device 200 includes parts in common with plurality of circuits 100. For example, both include a control subsystem comprising at least one processor 102, at least one input/output (I/O) subsystem 104, and at least one bus 106 to which the foregoing is coupled.

User device 200 includes at least one non-transitory computer or processor-readable storage device(s) 110 coupled to the bus(es) 106. Storage device(s) 110 include, but not limited to, a web browser 230, a calendar 232 and an aircraft ERP dashboard 234.

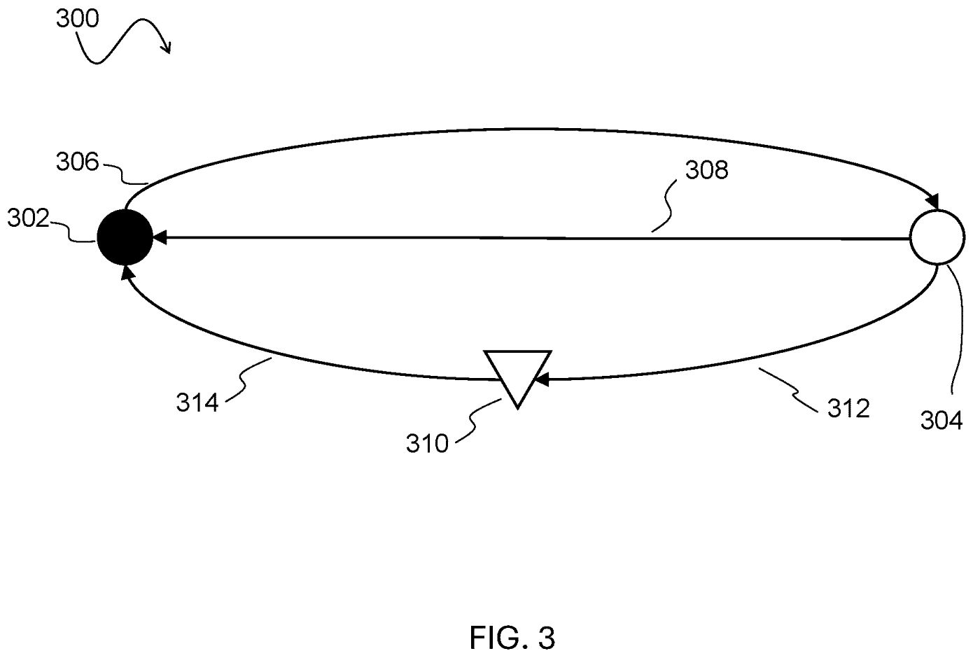

FIG. 3 which illustrates in schematic view a network 300 including a plurality of aerodromes and a plurality of routes amongst the plurality of aerodromes. The plurality of aerodromes includes a hub aerodrome 302 for example, the base of an aircraft operator. The routes amongst the plurality of aerodromes are directed. The schematic view helps explaining the actions of re-positioner 134.

An aircraft operator based at the hub aerodrome 302 can fly a plurality of route to other aerodromes such as aerodrome 304. As shown, the aircraft operator has flight from hub aerodrome 302 to aerodrome 304 on route 306. The aircraft operator plans for the aircraft to return on route 308. As illustrated, the aircraft flying route 306 is an empty leg with at least one seat available for booking.

As illustrated, the aircraft operator receives an option to divert or reposition to aerodrome 310 on route 312, change passengers and continue to hub aerodrome 302 on route 314.

For example, Alex and Barbara charter a float plane from Vancouver, BC, CA to Savary Island, BC, CA and specifically from the Vancouver Harbour aerodrome (IATA: CXH). They unload and the aircraft would return empty on route 306. Indeed, David and Emily booked seats on that return flight. However, the re-positioner 134 proposed, and the aircraft operator accepted, to transport Carlos from Savary Island to Pender Harbour, BC, CA (IATA: YPT). Thus, the aircraft is repositioned or diverted on route 312. In the same example, or a different example the aircraft operator could collect Frank in Pender Harbour and transport him to Vancouver.

As shown in FIG. 3 the diversion is a re-positioning of an aircraft on a leg. Other diversions, re-positioning, or changes include: change in at least one of the departure time, the arrival location, the plurality of routes and the alternative routes to accommodate one more extra passengers. Examples of these changes are further described herein.

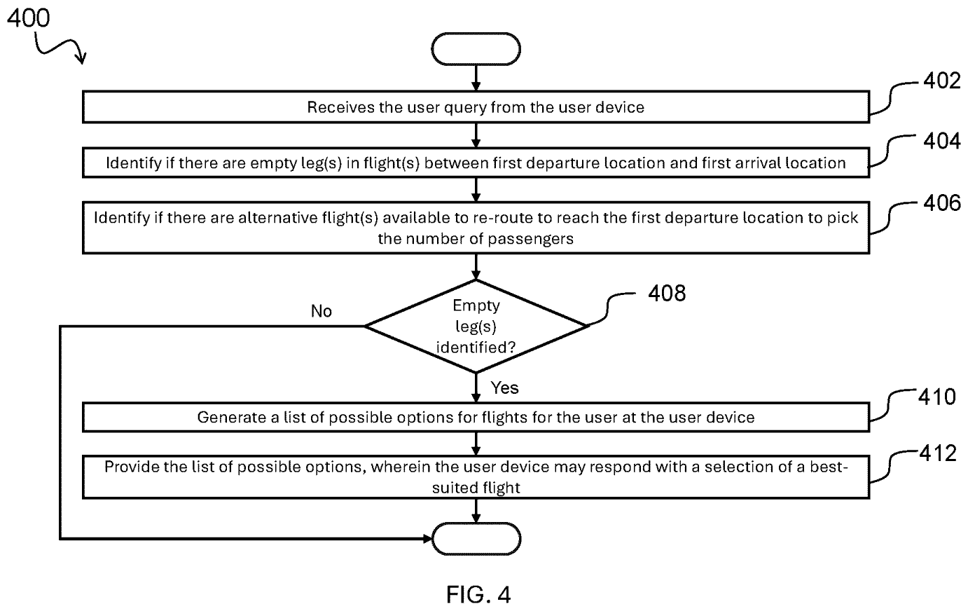

FIG. 4 illustrates an exemplary method 400 for use with the plurality of circuits 100 and the plurality of routes. Various embodiments of the plurality of circuits 100 and plurality of routes are described herein including in relation to FIG. 1 through FIG. 3. In particular, FIG. 4 shows method 400 that is executable by a controller, such as circuitry or at least one hardware processor, for the operation, or improvement in the operation, of a at least one aircraft.

A person skilled in the art will appreciate that other acts may be included, removed, and/or varied or performed in a different order to accommodate alternative implementations. The method 400 may be implemented at the bus(es) 106 through the one or more network or non-network communication channel(s) such as internet. The method 400 may be performed by the at least one processor 102 in conjunction with other components or systems as may be obvious to a person skilled in the art. In an embodiment, the at least one processor 102 may represent the analyser 136, the web server 130, the re-positioner 134, the scheduler 138 or any such described unit/component in the disclosure. In another embodiment, the at least one processor 102 may refer to a controller, for example, a controller subsystem, a hardware processor. The method 400 includes details for flight route operation and management, wherein the method 400 initiates at 402.

At 402, the at least one processor receives the user query from the user device 200, wherein the user query comprises the departure location, the arrival location, the departure time and the number of passengers.

At 404, the at least one processor identifies if there are one or more empty legs in flights between the departure location and the arrival location.

At 406, the at least one processor identifies if there are one or more alternative flights available to re-route to reach the departure location to pick the number of passengers.

At 408, if the one or more empty legs are identified, the method 400 continues to 410, else the method 400 ends.

At 410, the at least one processor generates a list of possible options for flights for the user at the user device 200.

At 412, the at least one processor provides the list of possible options, wherein the user at the user device 200 may respond with a selection of the best-suited flight. The possible options refer to change in at least one of the departure time, the arrival location, the plurality of routes and the alternative routes to accommodate the number of passengers. In another embodiment, the list of possible options is presented to the user at the user device 200 in a ranked order based on cost, the departure time or the arrival time.

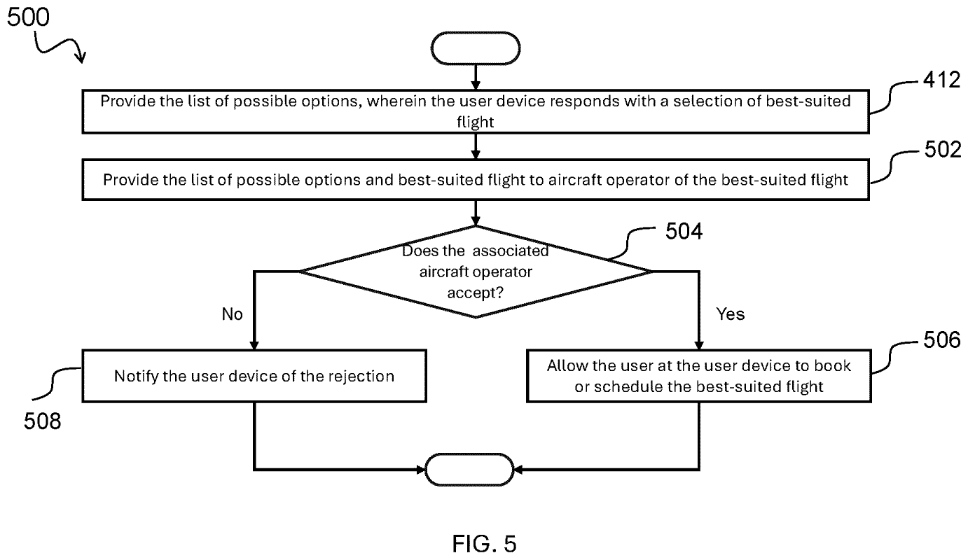

FIG. 5 illustrates another exemplary method 500 according to one embodiment of the invention for use with the plurality of circuits 100 and the plurality of routes. Various embodiments of plurality of circuits 100 and plurality of routes are described herein including in relation to FIG. 1 through FIG. 4. In particular, FIG. 5 shows method 500 that is executable by a controller, such as circuitry or at least one hardware processor, for the operation, or improvement in the operation, of at least one aircraft. Method 500 starts after 410 where the list of possible options is provided to the user at the user device 200, and the user may respond with the best-suited flight.

At 502, the at least one processor provides the list of possible options and the best-suited flight (mentioned at 410) to the aircraft operator of said best-suited flight.

At 504, the at least one processor checks if the associated aircraft operator accepts the change. If 504-Yes, method 500 continues at 506. If 504-No, method 500 continues at 508. That is, if the operator associated with the aircraft of the best-suited flight accepts the changes (mentioned in the list of possible options), method 500 continues to 506, else the method 500 continues at 508.

At 506, the at least one processor allows the user at the user device 200 to book or schedule the best-suited flight.

At 508, the at least one processor notifies the user at the user device 200 about the rejection made by said associated aircraft.

For clarity, various embodiments are included in this description. Each is a numbered example.

Example 1: A method of flight management and operation in a system including at least one processor, and a user device in communication with the at least one processor, the method comprising: receiving, at the at least one processor from the user device, a user query comprising a departure location, an arrival location, a departure time and a number of passengers; analysing, by the at least one processor, a flight database, to: identify if there is one or more empty leg in one or more flights between the departure location and the arrival location, and identify if there is one or more alternative flights available to re-route to reach the departure location to pick the number of passengers, wherein the flight database includes information characterizing one or more aircraft operators, a plurality of routes, alternative routes for the plurality of routes, a plurality of departure locations, a plurality of arrival locations, or number of occupied seats, number of total seats; accepting or rejecting, by the at least one processor, the user query based on the analysis of the flight database, wherein the user query is accepted by the at least one processor if the one or more empty leg is identified, and the user query is rejected by the at least one processor if the one or more empty leg is not identified; generating, by the at least one processor, a list of possible options for flights for a user at the user device if the user query is accepted, wherein said possible options refers to change in at least one of the departure time, the arrival location, the plurality of routes and the alternative routes to accommodate the number of passengers; and providing, by the at least one processor to the user device, the list of possible options, wherein the user device may respond with a selection of a best-suited flight.

Example 2: The method of claim 1 further comprising providing, by the at least one processor to an aircraft operator of the best-suited flight, the list of the possible options and the best-suited flight.

Example 3: The method of claim 2 further comprising notifying the user device in an event the aircraft operator of best-suited flight rejects the change in the best-suited flight.

Example 4: The method of claim 1 further comprising providing processor-executable instructions, which when executed by at the least one processor, determines if there is any affect on existing passengers of the best-suited flight in an event the best-suited flight is changed.

Example 5: The method of claim 1 further comprising providing, processor-executable instructions characterizing the list of possible options, which when executed presents the list of possible options to the user at the user device in a ranked order based on cost, the departure time or the arrival time.

Example 6: The method of claim 1 further comprising: providing processor-executable instructions, which when executed, provides an option to the user at the user device to update the user query, and receiving an updated user query from the user at the user device.

Example 7: The method of claim 1 further comprising updating the flight database if the information received from one or more aircraft operator includes an update.

Example 8: A system comprising: a user device, wherein the user device is processor-based; at least one processor communicatively coupled to the user device; and at least one non-transitory processor-readable storage device communicatively coupled to the at least one processor and which stores processor-executable instructions which, when executed by the at least one processor, cause the at least one processor to: receive a user query comprising a departure location, an arrival location, a departure time, and a number of passengers; analyse a flight database, to identify if there is one or more empty leg in one or more flights between the departure location and the arrival location; identify if there is one or more alternative flights available to re-route to reach the departure location to pick the number of passengers; accept or reject the user query based on the analysis of the flight database, wherein the user query is accepted if the one or more empty leg is identified, and the user query is rejected if the one or more empty leg is not identified; generate a list of possible options for flights for a user at the user device if the user query is accepted, wherein said possible options refers to change in at least one of the departure time, the arrival location, the plurality of routes and the alternative routes to accommodate the number of passengers; and provide the list of possible options to the user device, wherein the user device may respond with a selection of a best-suited flight.

Example 9: The system of claim 8, wherein when executed, the processor-executable instructions further cause the at least one processor to provide the list of the possible options and the best-suited flight to an aircraft operator of the best-suited flight.

Example 10: The system of claim 9, wherein when executed, the processor-executable instructions further cause the at least one processor to notify the user device in an event the aircraft operator of the best-suited flight rejects the change in the best-suited flight.

Example 11: The system of claim 8, wherein when executed, the processor-executable instructions further cause the at least one processor to determine if there is any affect on existing passengers of the best-suited flight if the best-suited flight is changed.

Example 12: The system of claim 8, wherein when executed, the processor-executable instructions further cause the at least one processor to present the list of possible options to the user device in a ranked order based on cost, the departure time or the arrival time.

Example 13: The system of claim 8, wherein when executed, the processor-executable instructions further cause the at least one processor to provide an option to the user at the user device to update the user query and receive an updated user query from the user at the user device.

Example 14: The system of claim 8, wherein when executed, the processor-executable instructions further cause the at least one processor to update the flight database if the information received from one or more aircraft operator includes an update.

Example 15: A system comprising a user device, at least one processor and at least one non-transitory processor-readable storage device, wherein said system performs steps of: receiving a user query comprising a departure location, an arrival location, a departure time and a number of passengers; analysing to identify if there is one or more empty leg in one or more flights between the departure location and the arrival location, and identify if there is one or more alternative flights available to re-route to reach the departure location to pick the number of passengers; accepting or rejecting the user query based on the analysis of the flight database, wherein the user query is accepted if the one or more empty leg is identified, and the user query is rejected if the one or more empty leg is not identified; generating a list of possible options for flights for a user at the user device if the user query is accepted, wherein said possible options refers to change in at least one of the departure time, the arrival location, the plurality of routes and the alternative routes to accommodate the number of passengers; and providing the list of possible options to the user device to respond with a selection of a best-suited flight the list.

1. A method of flight management and operation in a system including at least one processor, and a user device in communication with the at least one processor, the method comprising:
receiving, at the at least one processor from the user device, a user query comprising a departure location, an arrival location, a departure time and a number of passengers;
analyzing, by the at least one processor, a flight database, to:
identify if there is one or more empty leg in one or more flights between the departure location and the arrival location, and
identify if there is one or more alternative flights available to re-route to reach the departure location to pick the number of passengers, wherein the flight database includes information characterizing one or more aircraft operators, a plurality of routes, alternative routes for the plurality of routes, a plurality of departure locations, a plurality of arrival locations, or number of occupied seats, number of total seats;
accepting or rejecting, by the at least one processor, the user query based on the analysis of the flight database, wherein
the user query is accepted by the at least one processor if the one or more empty leg is identified, and
the user query is rejected by the at least one processor if the one or more empty leg is not identified;
generating, by the at least one processor, a list of possible options for flights for a user at the user device if the user query is accepted, wherein said possible options refers to change in at least one of the departure time, the arrival location, the plurality of routes and the alternative routes to accommodate the number of passengers; and
providing, by the at least one processor to the user device, the list of possible options, wherein the user device may respond with a selection of a best-suited flight.

2. The method of claim 1 further comprising providing, by the at least one processor to an aircraft operator of the best-suited flight, the list of the possible options and the best-suited flight.

3. The method of claim 2 further comprising notifying the user device in an event the aircraft operator of best-suited flight rejects the change in the best-suited flight.

4. The method of claim 1 further comprising providing processor-executable instructions, which when executed by at the least one processor, determines if there is any affect on existing passengers of the best-suited flight if the best-suited flight is changed.

5. The method of claim 1 further comprising providing, processor-executable instructions characterizing the list of possible options, which when executed presents the list of possible options to the user at the user device in a ranked order based on cost, the departure time or the arrival time.

6. The method of claim 1 further comprising:
providing processor-executable instructions, which when executed, provides an option to the user at the user device to update the user query, and
receiving an updated user query from the user at the user device.

7. The method of claim 1 further comprising updating the flight database if the information received from one or more aircraft operator includes an update.

8. A system comprising:
a user device, wherein the user device is processor-based;
at least one processor communicatively coupled to the user device; and
at least one non-transitory processor-readable storage device communicatively coupled to the at least one processor and which stores processor-executable instructions which, when executed by the at least one processor, cause the at least one processor to:
receive a user query comprising a departure location, an arrival location, a departure time, and a number of passengers;
analyze a flight database, to identify if there is one or more empty leg in one or more flights between the departure location and the arrival location;
identify if there is one or more alternative flights available to re-route to reach the departure location to pick the number of passengers;
accept or reject the user query based on the analysis of the flight database, wherein the user query is accepted if the one or more empty leg is identified, and
the user query is rejected if the one or more empty leg is not identified;
generate a list of possible options for flights for a user at the user device if the user query is accepted, wherein said possible options refers to change in at least one of the departure time, the arrival location, the plurality of routes and the alternative routes to accommodate the number of passengers; and
provide the list of possible options to the user device, wherein the user device may respond with a selection of a best-suited flight.

9. The system of claim 8, wherein when executed, the processor-executable instructions further cause the at least one processor to provide the list of the possible options and the best-suited flight to an aircraft operator of the best-suited flight.

10. The system of claim 9, wherein when executed, the processor-executable instructions further cause the at least one processor to notify the user device in an event the aircraft operator of the best-suited flight rejects the change in the best-suited flight.

11. The system of claim 8, wherein when executed, the processor-executable instructions further cause the at least one processor to determine if there is any affect on existing passengers of the best-suited flight if the best-suited flight is changed.

12. The system of claim 8, wherein when executed, the processor-executable instructions further cause the at least one processor to present the list of possible options to the user device in a ranked order based on cost, the departure time or the arrival time.

13. The system of claim 8, wherein when executed, the processor-executable instructions further cause the at least one processor to provide an option to the user at the user device to update the user query and receive an updated user query from the user at the user device.

14. The system of claim 8, wherein when executed, the processor-executable instructions further cause the at least one processor to update the flight database if the information received from one or more aircraft operator includes an update.

15. A system comprising a user device, at least one processor and at least one non-transitory processor-readable storage device, wherein said system performs steps of:
receiving a user query comprising a departure location, an arrival location, a departure time and a number of passengers;
analyzing to identify if there is one or more empty leg in one or more flights between the departure location and the arrival location, and identify if there is one or more alternative flights available to re-route to reach the departure location to pick the number of passengers;
accepting or rejecting the user query based on the analysis of the flight database, wherein the user query is accepted if the one or more empty leg is identified, and the user query is rejected if the one or more empty leg is not identified;
generating a list of possible options for flights for a user at the user device if the user query is accepted, wherein said possible options refers to change in at least one of the departure time, the arrival location, the plurality of routes and the alternative routes to accommodate the number of passengers; and
providing the list of possible options to the user device to respond with a selection of a best-suited flight the list.
